(19) United States
(12) Patent Application Publication
(10) Pub. No.: US 2021/0064278 A1
(43) Pub. Date: Mar. 4, 2021

(54) MANAGING ATTRIBUTES OF MEMORY COMPONENTS

(71) Applicant: Micron Technology, Inc., Boise, ID (US)

(72) Inventors: Suresh Rajgopal, San Diego, CA (US); Ali Feiz Zarrin Ghalam, Sunnyvale, CA (US)

(21) Appl. No.: 16/552,484

(22) Filed: Aug. 27, 2019

(51) Int. Cl. G06F 3/06; G06F 12/0802

(52) U.S. Cl. CPC G06F 3/0659; G06F 3/061; G06F 12/0246; G06F 3/0679; G06F 12/0802; G06F 3/0658

(57) ABSTRACT

Aspects of the present disclosure provide systems and methods for managing configuration, timing, and power parameters in memory sub-systems through the allocation of an I/O expander at a position between the controller and a drive that comprises a plurality of NAND dies. In particular, a memory controller is coupled to a drive with an I/O expander, and the I/O expander is assigned a LUN address of one or more memory components of the drive. A user or administrator of the host system can generate requests to configure target features of memory components of the drive by causing the I/O expander to decouple portions of the drive to provide a logical pathway between the memory controller and one or more memory components through reference to the corresponding LUN addresses.

### TECHNICAL FIELD

Embodiments of the disclosure relate generally to memory sub-systems and, for example, to managing attributes of memory components.

### BACKGROUND

A memory sub-system can be a storage system, a memory module, or a hybrid of a storage device and memory module. The memory sub-system can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory sub-system, in accordance with some embodiments of the present disclosure.

FIG. 2 is a flow diagram of an example method to configure attributes of memory components, in accordance with some embodiments of the present disclosure.

FIG. 3 illustrates an example memory sub-system that includes an addressable input/output (I/O) expander located between a memory sub-system controller and a plurality of memory components, in accordance with some embodiments of the present disclosure.

FIG. 4 illustrates an interaction diagram depicting the flow of data between a memory sub-system controller, an addressable I/O expander, and a plurality of memory components, in accordance with some embodiments of the present disclosure.

FIG. 5 is a block diagram of an example computer system in which embodiments of the present disclosure can operate.

### DETAILED DESCRIPTION

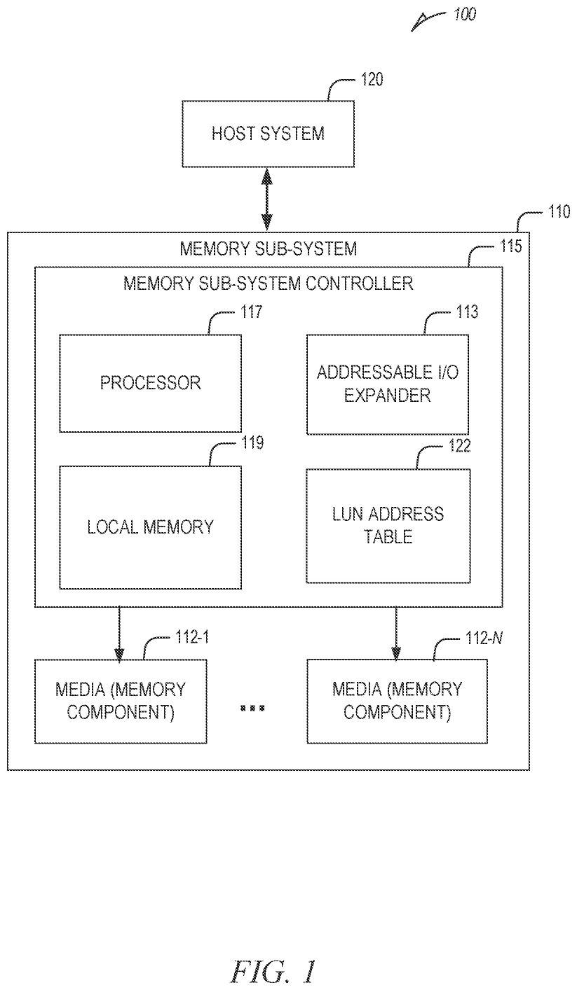

Aspects of the present disclosure are directed to managing attributes of memory components, which may be part of a memory sub-system. A memory sub-system can be a storage device, a memory module, or a hybrid of a storage device and memory module. Examples of storage devices and memory modules are described below in conjunction with FIG. 1. Memory sub-systems have become common components in computer systems ranging from mobile phones to large scale distributed cloud systems, to mission-critical on-premise server systems for financial and government institutions, and so on. As discussed above, as the requisite capacities of such memory sub-systems increase, each media (e.g., Logical Not-And (NAND) flash memory) interface of a memory sub-system controller (herein also referred to as a “controller”) connects to a greater number of media (e.g., NAND dies), resulting in large capacitive loads, which causes signal integrity issues at higher speeds.

Logical Not-And (NAND) flash memory is a type of nonvolatile storage technology that does not require power to retain data. NAND memory is used in SSDs that are extensively used in enterprise storage applications requiring high capacity and high-throughput performance. As the capacities of SSDs increases, each NAND interface of a controller needs to connect to an increasing number of NAND dies. This results in large capacitive loads, which can cause signal integrity issues at higher speeds.

Aspects of the present disclosure mitigate the fundamental tradeoffs by providing systems and methods for managing configuration, timing, and power parameters in memory sub-systems by coupling the controller with an SSD drive that comprises a plurality of NAND dies through use of an I/O expander. For example, coupling the controller with the SSD drive with an I/O port expander may include positioning the I/O port expander at a location functionally between the controller and the SSD drive. In particular, the I/O port expander (hereinafter referred to as an “I/O expander”) is functionally located between the controller and the SSD drive and is assigned the LUN addresses of the corresponding NAND dies of the SSD drive. For example, assigning the LUN addresses of the corresponding NAND dies of the SSD drive may include associating an identifier of the I/O expander with the LUN addresses in a LUN address table within a memory of the memory sub-system.

Based on the LUN (or LUNs), the I/O expander may isolate logical pathways to one or more NAND dies from the rest of the NAND dies, of the SSD, in a logical manner, thereby enabling commands to be routed from the controller to the one or more NAND dies. A LUN address can correspond to a particular SSD drive or can reference a specific NAND die of the SSD drive. As described in more detail herein, a LUN address, or a plurality of LUN addresses, can be shared between the I/O expander and the SSD drive, or memory components (e.g., NAND die) of the SSD drive. For example, in certain embodiments the memory sub-system can maintain a LUN address table to associate one or more LUN addresses with an identifier of an addressable I/O expander. In such embodiments, the memory sub-system can identify an I/O expander based on a LUN address included in a request.

The I/O expander can be configured to communicate with memory components from different manufacturers. To this end, the I/O expander may configure a vendor specific region of a Feature Address (FA) table (shown by way of example in Table 1 below) stored in the memory of the controller. Using the FA table, the host system can generate requests to configure various attributes of the SSD drive based on LUN address. In some embodiments, the I/O expander is active so that it can recondition signals, from the memory controller to the NAND dies (e.g., by re-timing or re-driving the signals).

In an example configuration, a memory sub-system may include a plurality of I/O expanders, functionally connected between a controller and a plurality of NAND dies. Responsive to communications from the host system, the controller can identify an appropriate I/O expander based on a LUN address, and cause the I/O expander to isolate an SSD drive (or a NAND die within the SSD drive) from other SSD drives (or NAND dies within the SSD drive) based on the LUN address. Commands are routed from the controller through the I/O expander identified by the LUN address to the corresponding SSD drive (or NAND dies within the SSD drive) to manage and configure one or more attributes of the drive. In some example embodiments, the commands include Open NAND Flash Interface Working Group (ONFI) compliant commands, such as SET Feature or GET Feature commands. Specific SET Feature and GET Feature sub-commands that may be supported include the Feature Address Configurable attributes can include, but are not limited to: drive output strength, timing modes, power modes, as well as test settings.

FIG. 1 illustrates an example computing environment 100 that includes a memory sub-system 110, in accordance with some embodiments of the present disclosure. The memory sub-system 110 can include media, such as memory components 112-1 to 112-N (e.g., NAND dies). The memory components 112-1 to 112-N can be volatile memory components, non-volatile memory components, or a combination of such. In some embodiments, the memory sub-system is a storage system. An example of a storage system is an SSD. In some embodiments, the memory sub-system 110 is a hybrid memory/storage sub-system. In general, the computing environment 100 can include a host system 120 that uses the memory sub-system 110. For example, the host system 120 can write data to the memory sub-system 110 and read data from the memory sub-system 110. As described in more detail below, the memory sub-system is shown to include an I/O Expander 113, in accordance with an example embodiment.

The I/O expander 113 may for example include an addressable I/O expander to connect a single port with a plurality of nodes through multiple, configurable ports. For example, by disabling one or more ports, an I/O expander can isolate one or more logical pathways between a port and one or more nodes. Accordingly, by coupling the memory sub-system controller 115 to the memory components 112-1 to 112-N with an addressable I/O expander 113, commands may be routed to one or more memory components from among the memory components 112-1 to 112-N based on a configuration of the addressable I/O expander 113.

According to certain embodiments, the memory sub-system may include a LUN address table 122, wherein the LUN address table 122 may be integrated within a package of the addressable I/O expander 113 or reside within a local memory 119 of the memory sub-system controller 115. In such embodiments, the LUN address table 122 may associate one or more LUN addresses of memory components from among the memory components 112-1 to 112-N to the addressable I/O expander 113.

The host system 120 can be a computing device such as a desktop computer, laptop computer, network server, mobile device, or such computing device that includes a memory and a processing device. The host system 120 can include, or be coupled to, the memory sub-system 110 so that the host system 120 can read data from or write data to the memory sub-system 110. The host system 120 can be connected to the memory sub-system 110 via a physical host interface. The connection can include an indirect communicative connection or direct communicative connection (e.g., without intervening components), whether wired or wireless, including connections such as electrical, optical, magnetic, etc. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), etc. The physical host interface can be used to transmit data between the host system 120 and the memory sub-system 110. The host system 120 can further utilize an NVM Express (NVMe) interface to access the memory components 112-1 to 112-N when the memory sub-system 110 is coupled with the host system 120 by the PCIe interface. The physical host interface can provide an interface for passing control, address, data, and other signals between the memory sub-system 110 and the host system 120.

The memory components 112-1 to 112-N can include any combination of the different types of non-volatile memory components and/or volatile memory components. An example of non-volatile memory components includes NAND type flash memory. Each of the memory components 112-1 to 112-N can include one or more arrays of memory cells such as single level cells (SLCs) or multi-level cells (MLCs) (e.g., triple level cells (TLCs) or quad-level cells (QLCs)). In some embodiments, a particular memory component can include both an SLC portion and a MLC portion of memory cells, wherein each NAND erase block may be put into any mode, including SLC, MLC, TLC, and QLC. Each of the memory cells can store one or more bits of data (e.g., data blocks) used by the host system 120. Although non-volatile memory components such as NAND type flash memory are described, the memory components 112-1 to 112-N can be based on any other type of memory such as a volatile memory. In some embodiments, the memory components 112-1 to 112-N can be, but are not limited to, random access memory (RAM), read-only memory (ROM), dynamic random access memory (DRAM), synchronous dynamic random access memory (SDRAM), phase change memory (PCM), resistive random access memory (RRAM), magnetic random access memory (MRAM—both toggle and spin transfer torque types), negative-or (NOR) flash memory, electrically erasable programmable read-only memory (EEPROM), and a cross-point, or 3d cross-point array (3DXP) of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory (as well as RRAM, MRAM) can perform a write in-place operation, where a non-volatile memory cell can be programmed without the non-volatile memory cell being previously erased. Furthermore, as noted above, the memory cells of the memory components 112-1 to 112-N can be grouped as data blocks that can refer to a unit of the memory component used to store data.

The memory sub-system controller 115 (hereinafter also referred to as “controller”) can interface with the host system 120 to facilitate communication with the memory components 112-1 to 112-N to perform operations such as reading data, writing data, or erasing data at the memory components 112-1 to 112-N and other such operations. The controller 115 can include hardware such as one or more integrated circuits and/or discrete components, a buffer memory, or a combination thereof. The controller 115 can be a microcontroller, special purpose logic circuitry (e.g., a field programmable gate array (FPGA), an application specific integrated circuit (ASIC), etc.), or other suitable processor. The controller 115 can include a processor (processing device) 117 configured to execute instructions stored in local memory 119. In the illustrated example, the local memory 119 of the controller 115 includes an embedded memory configured to store instructions for performing various processes, operations, logic flows, and routines that control operation of the memory sub-system 110, including handling communications between the memory sub-system 110 and the host system 120. In some embodiments, the local memory 119 can include memory registers storing memory pointers, fetched data, LUN addresses, etc. The local memory 119 can also include read-only memory (ROM) for storing micro-code. While the example memory sub-system 110 in FIG. 1 has been illustrated as including the controller 115, in another embodiment of the present disclosure, a memory sub-system 110 may not include a controller 115, and instead rely upon external control (e.g., provided by an external host, or by a processor or controller separate from the memory sub-system).

In general, the controller 115 can receive commands or operations, including ONFI commands such as SET Feature and GET Feature commands, from the host system 120 and can convert the commands or operations into instructions or appropriate commands to achieve the desired access to the memory components 112-1 to 112-N. The controller 115 can be responsible for other operations such as wear leveling operations, garbage collection operations, error detection and error-correcting code (ECC) operations, encryption operations, caching operations, and address translations between a logical block address and a physical block address that are associated with the memory components 112-1 to 112-N. The controller 115 can further include host interface circuitry to communicate with the host system 120 via the physical host interface. The host interface circuitry can convert the commands received from the host system into command instructions to access the memory components 112-1 to 112-N as well as convert responses associated with the memory components 112-1 to 112-N into information for the host system 120. In some embodiments, the host interface may include an ONFI interface to receive ONFI commands.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the controller 115 and decode the address to access the memory components 112-1 to 112-N.

In an example embodiment, the I/O expander 113 is configured to isolate and route ONFI commands from the memory sub-system controller 115 to an appropriate memory component (e.g., NAND die) from among the memory components 112-1 to 112-N based on a LUN. Accordingly, in some example embodiments, the memory components 112-1 to 112-N are grouped in to logical units that may each have a corresponding LUN address. In some embodiments, the I/O expander 113 is integrated into the controller 115 (as seen in FIG. 1), while in further embodiments the I/O expander 113 is physically located eternal to the controller. For example, the controller 115 can include a processor 117 configured to execute instructions stored in local memory 119 for performing the operations described herein.

The I/O expander 113 is functionally positioned between the controller 115 and the memory components 112-1 to 112-N, wherein the memory components 112-1 to 112-N have associated LUN addresses. The LUN addresses of the memory components 112-1 to 112-N can then be assigned to the addressable I/O expander 113. The I/O expander 113 may therefore enable the memory sub-system controller 115 to isolate one or more of the memory components 112-1 to 112-N based on a LUN address, to route commands received from the host system 120.

As mentioned above, the controller 115 may process requests that include ONFI commands received from the host 120. Table 1 below provides an example of a list of ONFI commands that are stored in the local memory 119.

TABLE 1

Command
Read Status
Read ID
Get Features
Set Features
LUN Get Features
LUN Set Features
ZQ Calibration Short
ZQ Calibration Long
Reset LUN
Synchronous Reset
Reset
Read Parameter Page
Volume Select

The “SET Feature” command (that writes EFh to a command register) is a mechanism to modify settings of a target feature of a drive, and the “GET Feature” command (that writes EEh to a command register) is a mechanism used to determine the current settings of a target feature of a drive. SET Feature and GET Feature commands are issued along with a “Feature Address” to identify the target feature to be modified or read. As discussed herein, the I/O expander 113 is configured to support SET Feature and GET Feature commands, including the SET Feature and GET Feature commands issued with the Feature Addresses listed in Table 2 below. Thus, the controller 115 may receive and process requests (from the host 120) that include an ONFI SET Feature or GET Feature command, a Feature Address, and a LUN address of a memory component, and route the commands to the appropriate memory components through an I/O expander associated with the LUN address within the LUN address table 122.

TABLE 2

| Feature Address | Description |
|---|---|
| 00h | Reserved |
| 01h | Timing Mode |
| 02h | NV-DDR2/NV-DDR3 configuration |
| 03-0Fh | Reserved |
| 10h | IO Drive Strength |
| 11h-2Fh | Reserved |
| 30h | External Vpp Configuration |
| 31h-4Fh | Reserved |
| 50h | EZ NAND Control |
| 51h-57h | Reserved |
| 58h | Volume Configuration |
| 59-5Fh | Reserved |
| 60h | BA NAND: Error Information |
| 61h | BA NAND: Configuration |
| 62h-7Fh | Reserved |
| 80h-FFh | Vendor Specific |
| 82h | NV-DDR3 supported configuration only |
| 90h | IO Drive Strength |
| 94h | Shutdown |

Accordingly, in an example embodiment, a logical pathway to one or more NAND dies can be isolated by assigning the LUN addresses of the one or more NAND dies to the I/O expander 113 in the LUN address table 122. The controller 115 can therefore identify the I/O expander 113 based on a LUN address assigned to the I/O expander 113 in the LUN address table 122 and cause the I/O expander 113 to isolate a logical pathway to the one or more NAND dies responsive to commands received from the controller 115. As an added benefit, coupling the controller 115 with the memory components 112-1 to 112-N using an I/O expander reduces timing margins due to inherent timing jitter that occurs in NAND devices with asynchronous interface.

As an illustrative example, consider an embodiment in which a NAND device comprises two memory components, wherein each of the memory components have a corresponding LUN address (LUN_1, and LUN_2). The LUN addresses may be associated with an I/O expander positioned between a controller and the NAND device, by assigning the LUN addresses to the I/O expander within a LUN address table.

A user of a host system can then cause the controller to generate a request to distribute ONFI commands directly to just LUN_1, or just LUN_2, by generating a request that includes an ONFI command and one or the above-mentioned LUN addresses. The controller can then reference the LUN address table to identify a corresponding I/O expander based on the LUN address of the request and cause the I/O expander to isolate one of the two components by decoupling loading to the controller. For example, the request may include the LUN address of LUN_1. The controller then identifies the I/O expander based on the LUN address, and causes the I/O expander to decouple the loading on the controller for LUN_2, thereby isolating a logical pathway between the controller and LUN_1, thus enabling the controller to deliver the command of the request to LUN_1.

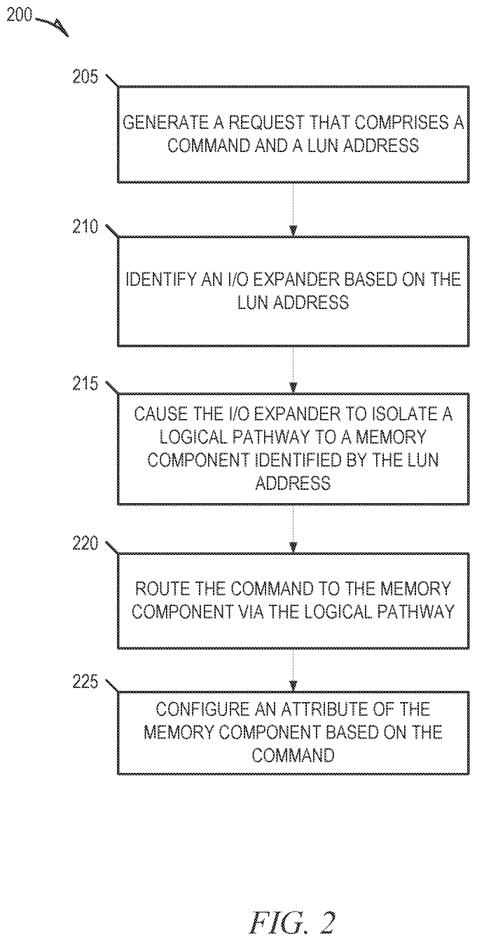

FIG. 2 is a flow diagram of an example method 200 to configure attributes of a drive, in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the power loss protection subsystem 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 205, a host system 120 generates a request that comprises a command, and a LUN address. For example, as discussed above, the command may include an ONFI SET Feature or GET Feature command which includes a feature address of a target feature to be modified of a memory component identified by the LUN address of the request.

The controller 115 receives the request generated by the host system 120, and at operation 210, identifies an I/O expander, such as the addressable I/O expander 113. In certain embodiments, the LUN address of the memory component may be associated with the I/O expander within a LUN address table 122. Responsive to receiving requests that include LUN address from the host system 120, the controller 115 references the LUN address table 122 to identify an I/O expander associated with the LUN address.

At operation 215, the controller 115 causes the I/O expander 113 assigned to the LUN address in the LUN address table 122, to isolate a logical pathway to the memory component identified by the LUN address. For example, as discussed above, isolating a logical pathway to the memory component identified by the LUN address may include causing the I/O expander 113 to decouple a portion of a drive not identified by the LUN address from the controller 115. Thus, at operation 220, the command received at the controller 115 can be routed to the memory component identified by the LUN address in the request, through the logical pathway provided by the I/O expander 113.

By doing so, at operation 225, an attribute of the memory component identified by the LUN address can be configured based on the command from the controller 115. For example, the command may include a GET Feature command, and a Feature Address to define a target feature to be configured. Attributes of the memory components that can be configured include, but are not limited to, drive output strength, timing modes, termination settings, power modes, and test settings, as seen in Table 2 above.

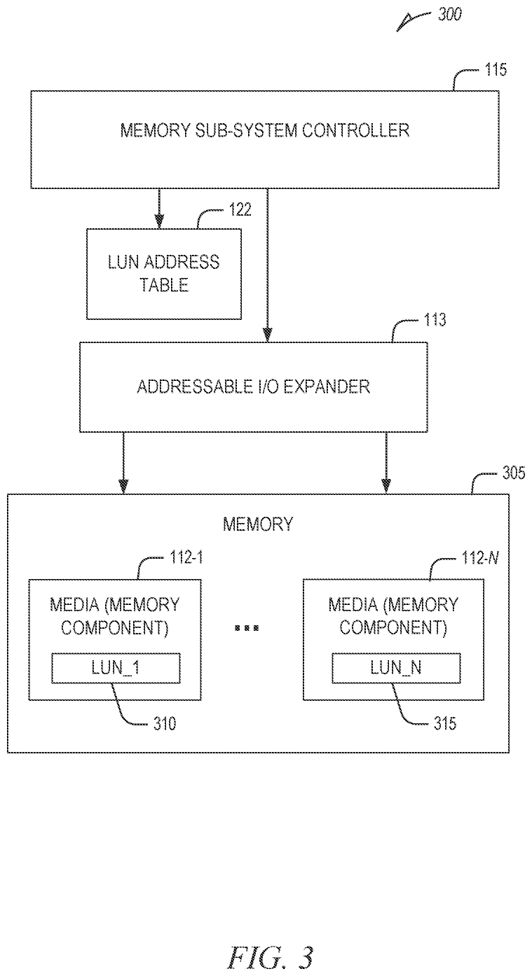

FIG. 3 illustrates an example memory sub-system 300 that includes an addressable I/O expander 113 at a position coupling the memory sub-system controller 115 with a memory 305 that comprises memory components 112-1 to 112-N, in accordance with some embodiments of the present disclosure. As in FIG. 1, the memory sub-system 300 depicted in FIG. 3 can include media, such as memory components 112-1 to 112-N, wherein the memory components 112-1 to 112-N can be volatile memory components, non-volatile memory components, or a combination of such. In some embodiments, the memory sub-system is a storage system. Each of the memory components 112-1 to 112-N can include a corresponding LUN address (e.g., LUN address 310 and LUN address 315) that identifies the memory component among the plurality of memory components.

As discussed above, a LUN address is a reference to a specific logical unit within the memory 305. For example, the logical unit (e.g., memory component 112-1) can be a part of a storage drive, such as the memory 305, and can be a reference to the entire storage drive itself, or a single memory component within the storage drive. As seen in FIG. 3, the memory components 112-1 to 112-N include corresponding LUN addresses (e.g., LUN address 310, and LUN address 315). In certain embodiments, the memory sub-system 300 may include a LUN address table 122, to associate one or more LUN address of memory components of the memory 305 to an I/O expander, such as the addressable I/O expander 113.

As described in the method 200 of FIG. 2 above, the controller 115 receives a request that comprises a command and a LUN address from the host 120, wherein the command may include an ONFI SET Feature or GET Feature command which includes a feature address of a target feature to be modified of a memory component identified by the LUN address of the request. The controller 115 receives the request and identifies the I/O expander 113 by referencing the LUN address table 122 based on the LUN address from the request.

The controller 115 causes the I/O expander associated with the LUN address in the LUN address table 122 (the addressable I/O expander 113) to isolate a logical pathway to the memory component identified by the LUN address. The controller 115 can then route the command from the request to the memory component identified by the LUN address, through the logical pathway provided by the I/O expander 113.

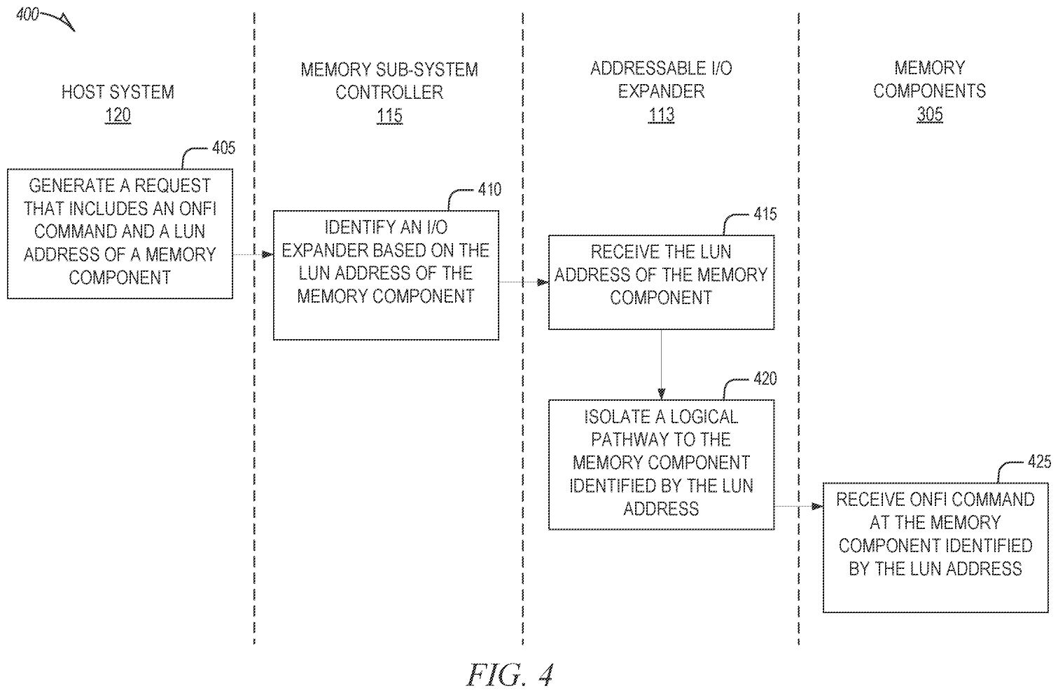

FIG. 4 illustrates an interaction diagram depicting the flow of commands between a host system 120, a memory sub-system controller 115, an addressable I/O expander 113, and a plurality of memory components 305, in accordance with some embodiments of the present disclosure. The memory components 305 depicted in FIG. 4 can include media, such as memory components 112-1 to 112-N depicted in FIG. 1, wherein the memory components 112-1 to 112-N can be volatile memory components, non-volatile memory components, or a combination of such. In some embodiments, the memory sub-system is a storage system. Each of the memory components 112-1 to 112-N can include a corresponding LUN address (e.g., LUN address 310 and LUN address 315) that identifies the memory component among the plurality of memory components.

The host system 120 generates a request that includes a command (such as an ONFI command), and a LUN address of a memory component from among the memory components 305, at operation 405. For example, the command may include a SET Feature, or GET Feature command, and a Feature Address of a target feature to be configured or read. In response to receiving the request from the host system 120, at operation 410 the memory sub-system controller 115 references a LUN address table, such as the LUN address table 122, and identifies the addressable I/O expander 113 based on the LUN address of the request.

At operation 415, the addressable I/O expander 415 receives the LUN address of the request from the memory sub-system controller 115, and at operation 420, isolates a logical pathway to the memory component identified by the LUN address by decoupling a portion of the memory components 305 from the memory sub-system controller 115. By doing so, at operation 425, the ONFI SET Feature or GET Feature command, and Feature Address provided in the request generated by the host system 120 can be routed to the memory component identified by the LUN address.

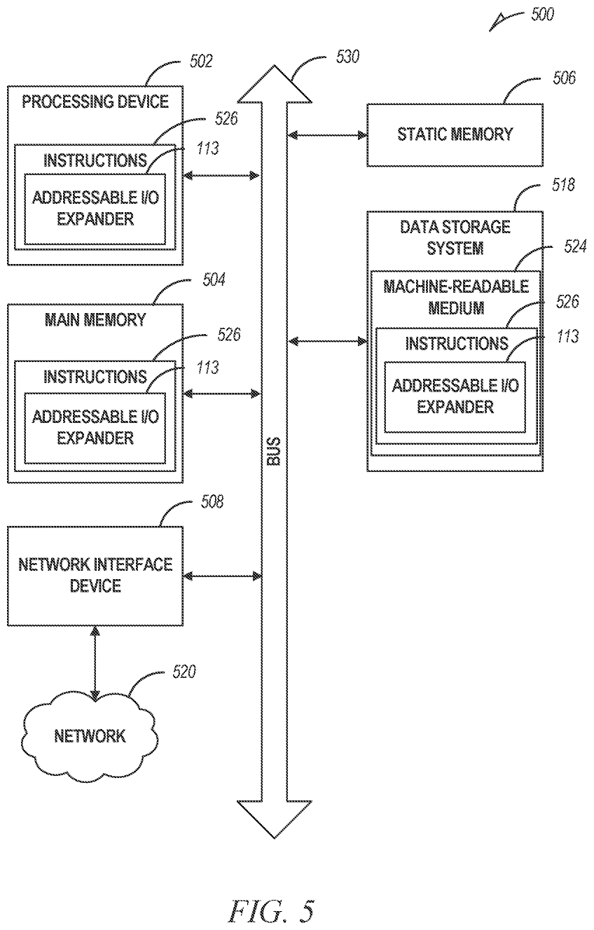

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the addressable I/O expander 113 of FIG. 1 and FIG. 3). In alternative embodiments, the machine can be connected (e.g., networked) to other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an ASIC, a FPGA, a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to the addressable I/O expander 113 of FIG. 1. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, and the like.

In the foregoing specification, embodiments of the disclosure have been described with reference to specific example embodiments thereof. It will be evident that various modifications can be made thereto without departing from the broader scope of embodiments of the disclosure as set forth in the following claims. The specification and drawings are, accordingly, to be regarded in an illustrative sense rather than a restrictive sense.

### EXAMPLES

Example 1 is a system comprising: a memory controller; a plurality of memory components comprising a plurality of non-volatile memory components and a volatile cache; and an I/O expander connected between the memory controller and the plurality of memory components, and configured to: receive a request that comprises an ONFI command, and a LUN address that identifies a memory component from among the plurality of memory components; identify the I/O expander based on the LUN address of the memory component; cause the I/O expander to isolate a logical pathway between the controller and the memory component from among the plurality of memory components identified by the LUN address; and route the ONFI command to the memory component from the memory controller to the memory component through the logical pathway.

In Example 2, the subject matter of Example 1, wherein the I/O expander includes an active I/O expander.

In Example 3, the subject matter of any one or more of Examples 1 and 2 wherein the operations to identify the I/O expander based on the LUN address of the memory component includes operation to: reference a LUN address table that associates the I/O expander with the LUN address of the memory component.

In Example 4, the subject matter of any one or more of Examples 1 through 3, wherein the plurality of memory components include NAND dies.

In Example 5, the subject matter of any one or more of Examples 1 through 4, wherein the command includes a Feature Address.

In Example 6, the subject matter of any one or more of Examples 1 through 5, wherein the command includes an ONFI command that includes one or more of a GET Feature command and a SET Feature command.

In Example 7, the subject matter of any one or more of Examples 1 through 6, wherein the memory component is a first memory component, the plurality of memory components further comprise a second memory component, and the operations to cause the I/O expander to isolate a logical pathway between the controller and the first memory component from among the plurality of memory components include operations to: cause the I/O expander to decouple the second memory component from the memory controller.

Example 8 is a method comprising: receiving a request that comprises an ONFI command, and a LUN address that identifies a memory component from among the plurality of memory components; identifying the I/O expander based on the LUN address of the memory component; causing the I/O expander to isolate a logical pathway between the controller and the memory component from among the plurality of memory components identified by the LUN address; and routing the ONFI command to the memory component from the memory controller to the memory component through the logical pathway.

In Example 9, the subject matter of Example 8, wherein the I/O expander includes an active I/O expander.

In Example 10, the subject matter of Example 8 and 9, wherein the identifying the I/O expander based on the LUN address of the memory component includes: referencing a LUN address table that associates the I/O expander with the LUN address of the memory component.

In Example 11, the subject matter of Examples 8 through 10, wherein the plurality of memory components include NAND dies.

In Example 12, the subject matter of any one or more of Examples 8 through 11, wherein the command includes a Feature Address.

In Example 13, the subject matter of any one or more of Examples 8 through 12, wherein the command includes an ONFI command that includes one or more of a GET Feature command and a SET Feature command.

In Example 14, the subject matter of any one or more of Examples 8 through 13, wherein the memory component is a first memory component, the plurality of memory components further comprise a second memory component, and the causing the I/O expander to isolate a logical pathway between the controller and the first memory component from among the plurality of memory components includes: causing the I/O expander to decouple the second memory component from the memory controller.

Example 15 is a non-transitory computer-readable storage medium comprising instructions that, when executed by a processing device, cause the processing device to perform operations comprising: receiving a request that comprises an ONFI command, and a LUN address that identifies a memory component from among the plurality of memory components; identifying the I/O expander based on the LUN address of the memory component; causing the I/O expander to isolate a logical pathway between the controller and the memory component from among the plurality of memory components identified by the LUN address; and routing the ONFI command to the memory component from the memory controller to the memory component through the logical pathway.

In Example 16, the subject matter of Example 15, wherein the I/O expander includes an active I/O expander.

In Example 17, the subject matter of any one or more of Examples 15 and 16, wherein the identifying the I/O expander based on the LUN address of the memory component includes: referencing a LUN address table that associates the I/O expander with the LUN address of the memory component.

In Example 18, the subject matter of any one or more of Examples 15 through 17, wherein the plurality of memory components include NAND dies.

In Example 19, the subject matter of any one or more of Examples 15 through 18, wherein the command includes a Feature Address.

In Example 20, the subject matter of any one or more of Examples 15 through 19, wherein the command includes an ONFI command that includes one or more of a GET Feature command and a SET Feature command.

1. A system comprising:
a plurality of memory components comprising a volatile cache, and a plurality of non-volatile memory components;
an input/output (I/O) expander, that includes an active I/O expander configured to recondition a signal that comprises one or more commands; and
a processing device, coupled to the plurality of memory components and the I/O expander, the processing device configured to perform operations comprising:
receiving a request that comprises an Open NAND Flash Interface (ONFI) command, and a logical unit number (LUN) address that identifies a memory component from among the plurality of memory components;
identifying the expander based on the LUN address of the memory component;
causing the I/O expander to isolate a logical pathway between the processing device and the memory component from among the plurality of memory components identified by the LUN address; and
routing the ONFI command to the memory component from the processing device to the memory component through the logical pathway.

2. The system of claim 1, wherein the routing the ONFI command to the memory component includes:
causing the active I/O expander to re-drive the ONFO command to the memory controller and the plurality of memory components.

3. The system of claim 1, wherein the identifying the I/O expander based on the LUN address of the memory component comprises:
referencing a LUN address table that associates the I/O expander with the LUN address of the memory component.

4. The system of claim 1, wherein the plurality of memory components comprises NAND die.

5. The system of claim 1, wherein the command comprises a feature address.

6. The system of claim 1, wherein the command comprises an ONFI command that includes a SET Feature command and a feature address, and the system is configured to perform operations further comprising:
configuring a parameter of the memory component based on the SET Feature command the feature address, in response to the routing the ONFI command to the memory component from the processing device to the memory component via the logical pathway.

7. The system of claim 1, wherein the memory component is a first memory component, the plurality of memory components further comprise a second memory component, and the causing the I/O expander to isolate a logical pathway between the processing device and the first memory component from among the plurality of memory components comprises:
causing the I/O expander to decouple the second memory component from the memory controller.

8. A method comprising:
receiving a request that comprises an ONFI command, and a LUN address that identifies a memory component from among a plurality of memory components;
identifying an I/O expander based on the LUN address of the memory component, the I/O expander including an active I/O expander configured to recondition a signal that comprises one or more commands;
causing the I/O expander to isolate a logical pathway between a memory controller and the memory component from among the plurality of memory components identified by the LUN address; and
routing the ONFI command to the memory component from the memory controller to the memory component through the logical pathway.

9. The method of claim 8, wherein the routing the ONFI command to the memory component includes:
causing the active I/O expander to re-drive the ONFO command to the memory controller and the plurality of memory components.

10. The method of claim 8, wherein the identifying the I/O expander based on the LUN address of the memory component includes:
referencing a LUN address table that associates the I/O expander with the LUN address of the memory component.

11. The method of claim 8, wherein the plurality of memory components include NAND dies.

12. The method of claim 8, wherein the command includes a Feature Address.

13. The method of claim 8, wherein the command includes an ONFI command that includes a SET Feature command and a feature address, and the method further comprises:
configuring a parameter of the memory component based on the SET Feature command the feature address of the ONFI command, in response to the routing the ONFI command to the memory component from the memory controller to the memory component through the logical pathway.

14. The method of claim 8, wherein the memory component is a first memory component, the plurality of memory components further comprise a second memory component, and the causing the I/O expander to isolate a logical pathway between the controller and the first memory component from among the plurality of memory components includes:
causing the I/O expander to decouple the second memory component from the memory controller.

15. A non-transitory computer-readable storage medium comprising instructions that, when executed by a processing device, cause the processing device to perform operations that include:
receiving a request that comprises an ONFI command, and a LUN address that identifies a memory component from among a plurality of memory components;
identifying an I/O expander based on the LUN address of the memory component, the I/O expander including an active I/O expander configured to recondition a signal that comprises one or more commands;
causing the I/O expander to isolate a logical pathway between a memory controller and the memory component from among the plurality of memory components identified by the LUN address; and
routing the ONFI command to the memory component from the memory controller to the memory component through the logical pathway.

16. The non-transitory computer-readable storage medium of claim 15, wherein the routing the ONFI command to the memory component includes:
causing the active I/O expander to re-drive the ONFO command to the memory controller and the plurality of memory components.

17. The non-transitory computer-readable storage medium of claim 15, wherein the identifying the I/O expander based on the LUN address of the memory component includes:
referencing a LUN address table that associates the I/O expander with the LUN address of the memory component.

18. The non-transitory computer-readable storage medium of claim 15, wherein the plurality of memory components include NAND dies.

19. The non-transitory computer-readable storage medium of claim 15, wherein the command includes a Feature Address.

20. The non-transitory computer-readable storage medium of claim 15, wherein the command includes an ONFI command that includes a SET Feature command and a feature address, and the processing device is configured to perform operations further comprising:
configuring a parameter of the memory component based on the SET Feature command the feature address of the ONFI command, in response to the routing the ONFI command to the memory component from the memory controller to the memory component through the logical pathway.
